(19) United States
(12) Patent Application Publication
(10) Pub. No.: US 2018/0215305 A1
(43) Pub. Date: Aug. 2, 2018

(54) MOTOR VEHICLE WITH COMPARTMENT AND LIFT TO RECEIVE ROLLING APPLIANCE

(71) Applicant: FORD MOTOR COMPANY, Dearborn, MI (US)

(72) Inventor: Benjamin MAUS, Duesseldorf NRW (DE)

(73) Assignee: FORD MOTOR COMPANY, Dearborn, MI (US)

(21) Appl. No.: 15/878,772

(22) Filed: Jan. 24, 2018

(30) Foreign Application Priority Data
Jan. 27, 2017 (DE) 102017201355.9

(51) Int. Cl. B60P 3/073; B62D 43/04

(52) U.S. Cl. CPC B60P 3/073; B62D 43/04

(57) ABSTRACT

A motor vehicle has an internal compartment for housing a rolling appliance (such an and unmanned ground vehicle) that is operable separately from the motor vehicle. A lift mechanism is secured to or within the vehicle adjacent to the compartment and is movable between a lowered condition wherein it alternatively receives/engages the rolling appliance when the rolling appliance is located beneath the compartment, and a raised condition wherein it has lifted the rolling appliance into the compartment, thereby moving the rolling appliance between the ground and the compartment. The compartment is immediately below a traditional cargo area of the vehicle and has a pass-through via which objects can be moved between the vehicle cargo area and a loading area of the rolling appliance.

### CROSS-REFERENCE TO RELATED APPLICATIONS

This application claims foreign priority benefits under 35 U.S.C. § 119(a)-(d) to DE Application 10 2017 201 355.9 filed Jan. 27, 2017, which is hereby incorporated by reference in its entirety.

### TECHNICAL FIELD

The invention relates to a system comprising a motor vehicle and an additional external rolling appliance which can be launched from and recovered into a compartment of the motor vehicle using a lift secured to the motor vehicle.

### BACKGROUND

Motor vehicles routinely have a cargo area in which objects can be stowed and carried. In the case of sedans and station wagons, a so-called trunk is provided for this purpose which is frequently in the rear of the vehicle, but in some types of vehicle the cargo area may be in the front of the vehicle. Reaching loaded objects frequently requires time and energy. Furthermore, appliances such as spare wheels or transport means (e.g. wheelchairs or trolleys) which are located in or at the cargo area may be very difficult to gain access to when the cargo area is full of other objects. The problem that arises is that of configuring the arrangement and transportation of corresponding appliances more effectively.

### SUMMARY

A first aspect of the invention relates to a system comprising a motor vehicle and an additional rolling appliance which can be received in a compartment enclosed within the body of the motor vehicle. The motor vehicle has a lift device for receiving and engaging the rolling appliance, wherein the lift is secured to the body of the motor vehicle and part of the lift is vertically movable, in such a manner that lift can be lowered in the direction of the ground and raised upwards in the direction of the body.

“Receiving” and “receivable” within the meaning of the rolling appliance relate to the fact that the appliance can be alternatively secured to and released from the vehicle. This also includes the fact that the appliance can be stowed in space, chamber, recess, or compartment provided therefor inside the vehicle.

The disclosed system is advantageous because, on the one hand, it allows the use of a rolling appliance which can transport objects from or to the vehicle in a time-saving and energy-saving manner. The rolling appliance is transported on the vehicle and can therefore be used any time at any location where the vehicle finds itself. Furthermore, the system allows an advantageous stowage of the rolling appliance in such a manner as to protect said appliance from loss, water and dirt.

The invention particularly relates to land vehicles and, in this case, particularly to motor vehicles. The term “motor vehicles” in this case encompasses sedans, station wagons, vans or trucks. The cargo area of the motor vehicle is usually located in or towards the rear of the motor vehicle, although it may also be in the front or middle. With regard to the receiving device for receiving the rolling appliance, partially height-adjustable means that at least part of the receiving device is vertically movable, e.g. one end or side, while an opposite side may not be vertically movable relative to the vehicle and/or the ground surface.

The rolling appliance may, in particular, be understood to be a mobile transport appliance such as an unmanned ground vehicle (UGV). However a spare wheel, for example, may also be stowed in the device as an rolling appliance.

The term “ground” in this case relates to the surface on which the motor vehicle stands and moves. This may be a paved road or a corresponding road surfacing, but also unpaved tracks, lawns, etc.

An area, compartment, or space is provided inside of the body of the motor vehicle, in which the rolling appliance can be received and transported by and along with the motor vehicle. In other words, a specific space for receiving is provided to house the receiving device. This compartment may, for example, take the shape of a recess, so that the rolling appliance which is received is roughly flush with the lower surface of the body.

The height-adjustable (capable of being moved vertically between a raised and a lowered condition) lift of the receiving device may be configured in the form of at least one clamp which is movable in a vertical direction between the body of the motor vehicle and the ground. In this way, the rolling appliance can be engaged or gripped by the receiving device, in other words received and pulled upward toward the body of the motor vehicle where the clamp(s) support or retain the rolling appliance within the compartment, or alternatively lowered from the body toward the ground and released.

In a further embodiment, the height-adjustable lift comprises a platform which is movable in a vertical direction between the lower surface or portion of the body of the motor vehicle and the ground surface. In this embodiment, the rolling appliance can roll onto and off of the platform when it is in the lowered condition, in order to be moved upward toward the body and into the compartment (where the appliance is supported on top of the platform) or lowered out of the compartment toward the ground, so that it can roll away from the platform.

In a further embodiment, the height-adjustable lift can be supplied by lowering as a platform in the form of an inclined plane or ramp onto and off of which the rolling appliance can roll, so that it comes to rest with the front side in the direction of the ground and is then stowed by lifting up the height-adjustable part on the vehicle, or else from which the rolling appliance can roll off and away from the platform in the lowered state. The platform in this case is preferably pivotably mounted on a first end and a second, opposite end of the platform can be lowered toward the ground. The lift is supplied by lowering in this case as an inclined plane onto which the rolling appliance can move or be moved, so that it comes to rest with the front end in the direction of the ground. In this way, the rolling appliance can get onto the platform, so that it can be moved with the second end of the platform in the direction of the ground. It is particularly preferable in this case for the pivotably mounted side to be mounted about an axis running in the transverse vehicle direction.

The compartment and associated lift are preferably arranged below the traditional cargo area of the motor vehicle. In this way, the lift can be advantageously arranged in a section of the cargo area which is used in traditional motor vehicles for storing a spare tire.

Furthermore, it is preferable for the cargo area of the motor vehicle to have a cargo floor and for the cargo floor to have a pass-through opening, via which objects can be exchanged between the cargo area of the motor vehicle and a loading area of the rolling appliance.

The rolling appliance may be an unmanned ground vehicle (UGV) that is remote-controlled. For this purpose, the appliance has a receiving device, for example, which can receive commands transmitted from the vehicle or another point. Likewise, the rolling appliance may be a stand-up-device, i.e. a device which is provided both to transport people and also to transport objects. Operation in this case is likewise by remote control, wherein a person standing on the stand-up device can give control commands via a transmitting device, or a person as described above controls the appliance loaded with an object, for example, by remote control.

The rolling appliance may be a UGV that operates autonomously. For this purpose, the UGV has a control module, for example, which issues control commands by means of which the UGV reaches a predetermined destination. The UGV may also be configured both for autonomous movement and for remote control. Consequently, the UGV may also be understood to be a delivery robot.

The term UGV is commonly understood to describe a vehicle that operates while in contact with the ground and without an onboard human presence. Generally, the UGV will have a set of sensors to observe the environment, and will either autonomously make decisions about its behavior or pass the information to a human operator at a different location who will control the vehicle through teleoperation (remote control).

A second aspect of the invention relates to a method of operating a system according to the invention comprising the steps:

provision of the rolling appliance in the region of the receiving device, so that it can be moved away from the receiving device,

receiving of the rolling appliance by the height-adjustable part of the receiving device,

upwards movement of the height-adjustable part of the receiving device,

lowering of the height-adjustable part of the receiving device and release of the rolling appliance.

The advantages of the method correspond to the advantages of the system according to the invention.

The invention is explained in greater detail with the help of the figures. In the figures

### BRIEF DESCRIPTION OF THE DRAWINGS

FIG. 1 shows a schematic representation of a first disclosed embodiment of a system according to the invention;

FIG. 2 shows a schematic representation of the embodiment according to FIG. 1 in a different state;

FIG. 3 shows a schematic representation of a second embodiment of a system according to the invention;

FIG. 4 shows a schematic representation of a third embodiment of a system according to the invention; and

FIG. 5 shows a flow diagram of an embodiment of the method according to the invention.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

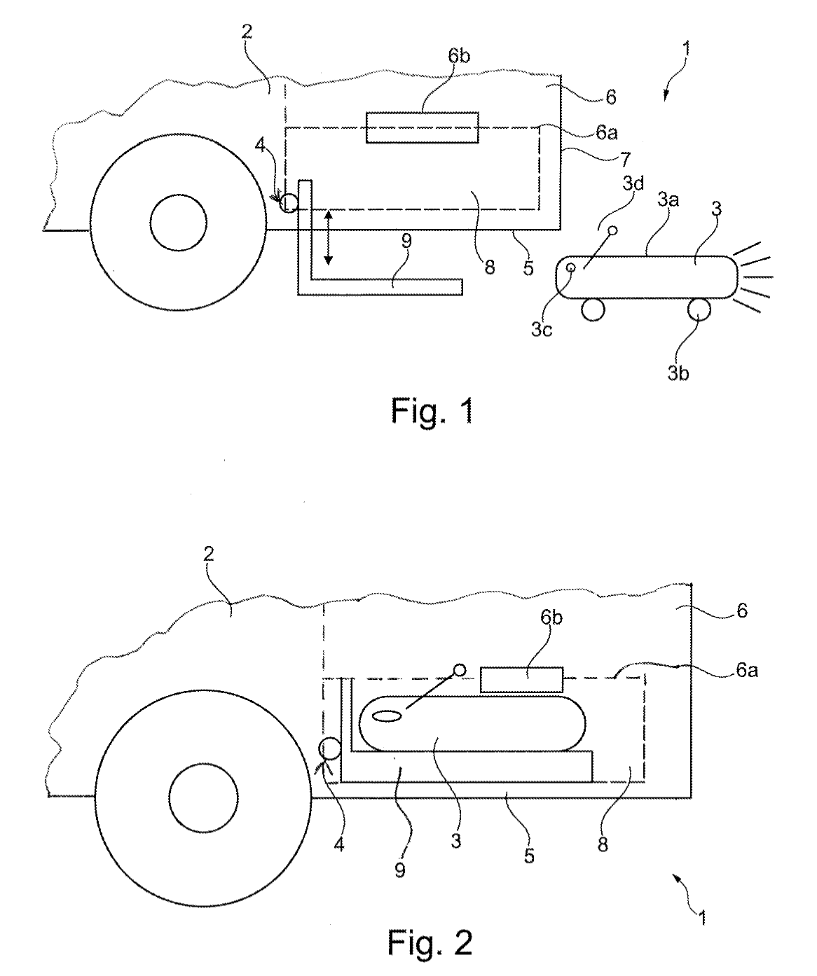

FIG. 1 depicts a system 1 according to a first embodiment of the invention comprising a vehicle 2 and a rolling appliance 3 that is operable separately and independently from the vehicle. The vehicle is generally depicted as being a sedan, for example, although it may also be another type of vehicle, e.g. a station wagon or a van.

The rolling appliance 3, as depicted in FIG. 1, has a loading area 3a, wheels 3b for locomotion, lighting devices 3c, and a fitting 3d for operation. In this case, the rolling appliance 3 is shown as a transport appliance with a loading area 3a on or into which objects to be transported may be placed. In this case it may also be configured as a stand-up-device. Alternatively or in addition to the wheels 3b, the rolling appliance may also have leg-like mechanisms (not shown) which allow stair-climbing, for example. The rolling appliance 3 has a control device (not shown) which is able to receive commands and issue control commands. The rolling appliance 3 may be moved by remote control or autonomously following a route that has been programmed into the control device. It is furthermore possible for the rolling appliance to be a spare wheel for the vehicle 2.

A compartment 8 for housing the rolling appliance 3 is defined within the vehicle body, e.g. immediately above a lower surface of the body 5 (commonly referred to as the underbody) and immediately below a cargo area 6 of the vehicle 2. A lift mechanism 4 is secured to the lower portion of the vehicle body 5 and may be disposed at least partially within the compartment 8.

Alternatively, the lift mechanism may be arranged in a front region of the vehicle if the cargo area of the vehicle is in the front region. The lift 4 and/or the compartment 8 may have a protective device, e.g. a rain protector in the form of a tarpaulin, to protect the device 4 and the rolling appliance 3 from dirt, wet and mechanical action.

The lift 4 comprises a platform 9, at least a portion of which is movable in the vertical direction. An opening 5a is defined in the lower surface of the body 5 at the bottom of the compartment 8, such that the platform 9 is movable downward through the opening to a lowered condition wherein it is positioned to receive of engage the rolling appliance 3 which is rolling on the ground, e.g. a road surface. The platform 9 is further/alternatively movable upward to lift the appliance 3 through the opening 5a and to a raised condition wherein the platform supports the appliance within the compartment 8. The vertical double arrow adjacent to the height-adjustable platform 9 indicates the direction of the movement between the raised and lowered conditions. When the platform 9 is in the raised condition (FIG. 2), the platform preferably substantially closes off or seals the opening 5a.

In FIGS. 1 and 2 the height-adjustable portion of the lift is configured in the form of a platform 9. In FIG. 1 the platform 9 is lowered, so that the rolling appliance 3 can roll thereon, after which the platform is drawn upward toward the body 5 (see FIG. 2). In this raised position, the rolling appliance 3 is housed within the compartment and therefore can be transported along with and internal to the vehicle 2. If it is desired for the rolling appliance 3 to again move independently from the vehicle, the platform 9 is moved to its lowered condition (lying against or closely adjacent to the ground surface) so that the rolling appliance 3 can roll off the platform. It will be clear to the person skilled in the art in this case how the height adjustment is accomplished, e.g. using motors and/or cable pulls.

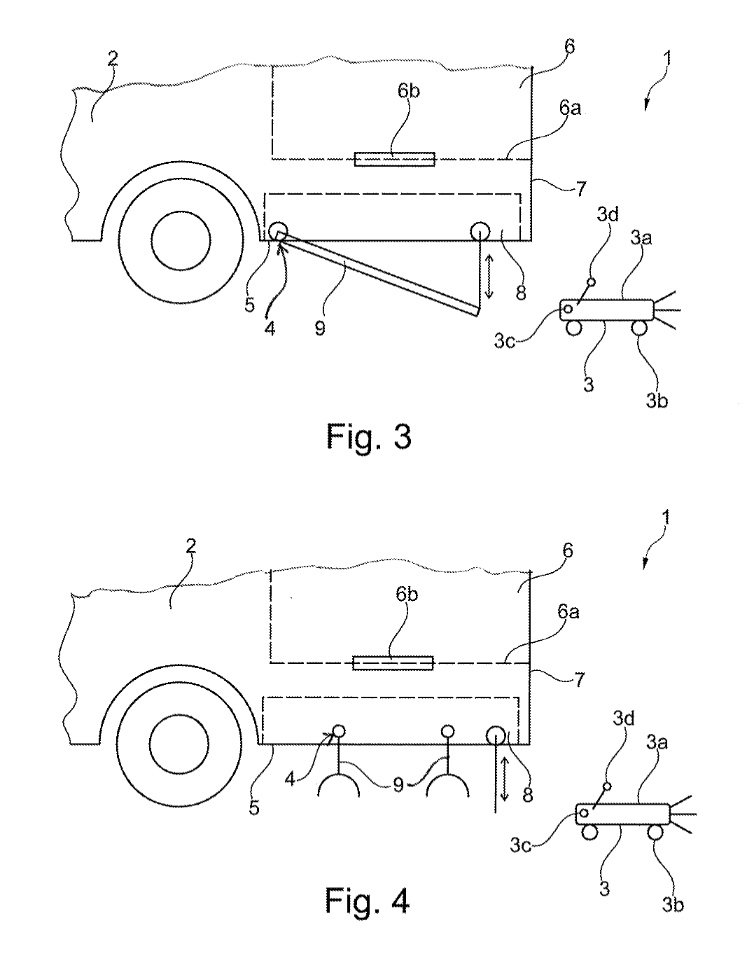

In FIG. 3 the lift mechanism 34 comprises a platform 39 that is pivotably mounted to the lower portion of vehicle body 35 to permit rotation of the platform about an axis running parallel to the transverse vehicle direction, e.g. via one or a plurality of hinge joints. The edge or end of the platform 39 closest to the rear of the vehicle 2 is therefore movable upward and downward, the double arrow in this case denoting the up and down movement. In the lowered condition, the platform 39 slopes downward from the vehicle to the ground surface so that the appliance 3 can roll upward onto the sloping platform, after which the platform is pulled upward in the direction of the body 35. In this raised condition the platform 39 supports the appliance 3 within the compartment 38 (in a configuration generally similar to that shown in FIG. 2) so that the appliance 3 is transported with the vehicle. If the rolling appliance 3 is to operate separately form the vehicle 2 again, the platform 39 is lowered again to the sloping/inclined position and the appliance can roll down and off of the platform. It will be clear to the person skilled in the art in this case how the height adjustment of the platform 39 is accomplished.

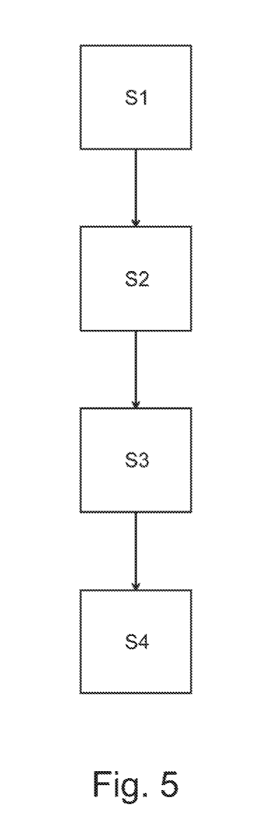

In FIG. 4 the lift mechanism comprises two clamps 49 that are vertically movable relative to the vehicle 2. The double arrow in this case shows the up and down movement of the clamps 49. When clamps 49 are in the lowered condition shown in FIG. 4, the rolling appliance 3 may roll into a position directly below the compartment 8 and the opening 45b in order to be engaged or gripped by the clamps. The appliance 3 may then be pulled upward toward the vehicle body 45 and into the compartment 8. In this position, the rolling appliance 3 can be transported with the vehicle. When the rolling appliance 3 is to operate separately form the vehicle 2 again, the clamps 49 are lowered again, the grip of the clamps is released, and the rolling appliance can roll away from the vehicle. It will be clear to the person skilled in the art in this case how the height adjustment is accomplished.

The cargo area 6 has a load floor 6a. In FIGS. 3 and 4, the load floor 6a has a pass-through 6b formed therein which provides physical communication between the cargo area 6 and the compartment 8. The pass-through 6b may be closable, e.g. using a cover, and can be envisaged as a kind of hatchway. The pass-through 6b permits a person with access to the cargo area 6 from above to move objects from the cargo area 6 of the vehicle onto the loading area 3a of the rolling appliance, or vice versa. The movement of objects can take place manually in this case or, alternatively, using a device (not shown) provided for this purpose. If the cargo area 6 of the motor vehicle 6 has no pass-through 6b, the transfer of objects between the rolling appliance 3 and the cargo area 6 can be performed prior to the rolling appliance being engaged by the lift and raised into the compartment.

In an embodiment of the method according to the invention for operating the system according to one of the representations in FIGS. 1-4, according to the representation in FIG. 5 in a first step S1 the rolling appliance 3 is provided in the region of the lift device 4, so that it can be moved from the lift device 4. For example, it is already in the stowed position in the recess 8.

If the rolling appliance 3 is not on the vehicle, it is received and engaged in a second step S2 by the lift device 4. This is the case, for example, if the rolling appliance is transporting an object to the vehicle from another location. For this purpose, the height-adjustable lift part is lowered from the lower region of the body, e.g. from the recess 8, to the level of the ground, e.g. of a road. The rolling appliance then rolls onto a platform (as depicted in FIGS. 1 & 3, for example), or under the clamps which grip the rolling appliance 3 (as depicted in FIG. 4). The height-adjustable lift part is then moved upwards in a third step S3, so that the rolling appliance is supported within the compartment by the lift.

If there is a pass-through 6b in the cargo area 6 and if objects are to be transported using the rolling appliance, this can be opened for the transfer of objects. In this way, a connection is provided between the cargo area of the vehicle 6a and the loading area 3a of the rolling appliance. An object, e.g. a suitcase, may be transferred from the loading area 6a of the vehicle onto the loading area 3a of the rolling appliance. Alternatively, if the rolling appliance 3 has transported an object to the vehicle, the object may be transferred from the loading area 3a of the rolling appliance 3 into the cargo area 6 of the vehicle. This may take place manually or by means of a special device (not shown) which may be provided for this purpose. The pass-through 6b is then closed again.

If the rolling appliance 3 is then to travel from the vehicle 2 to another location, e.g. in order to move the loaded object(s) to the other location, the height-adjustable lift part 9 is lowered in a fourth step S4, so that the rolling appliance 3 can disengage from the lift 4 and travel under its own power away from the vehicle 2 to the location to which the object is to be delivered. If the rolling appliance 3 is not to travel away from the vehicle, it may remain in the lift device 4.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. Apparatus comprising:
an unmanned ground vehicle (UGV);
a motor vehicle having a body defining a compartment and an opening communicating with an exterior of the vehicle beneath the compartment; and
a lift secured to the body of the motor vehicle adjacent to the opening and movable between a lowered condition wherein the lift is positioned for engagement with and disengagement from the UGV when the UGV is located below the lower opening, and a raised condition wherein the lift supports the UGV inside the compartment.

2. The apparatus of claim 1, wherein the compartment is disposed immediately below a cargo area of the vehicle.

3. The apparatus of claim 2, wherein a floor separates the cargo area from the compartment, and a pass-through opening is formed in the floor to permit objects to be exchanged between the cargo area of the motor vehicle and a cargo area of the UGV.

4. The apparatus of claim 1, wherein the lift comprises a platform that, when in the lowered condition, is positioned such that at least a portion of the platform is adjacent to a ground surface to allow the UGV to roll on and off the platform.

5. The apparatus of claim 4, wherein a first end of the platform is pivotably mounted to the vehicle and a second end of the platform can be lowered toward the ground surface such that the platform is inclined relative to the ground surface.

6. The apparatus of claim 1, wherein the lift comprises at least one clamp operable to alternatively grip and release the UGV when the clamp is in the lowered condition.

7. Apparatus comprising:
a rolling appliance;
a motor vehicle having an internal compartment; and
a platform secured to a body of the vehicle adjacent to a lower opening of the compartment and movable between a lowered condition wherein the platform is positioned to allow the appliance, when on a surface below the vehicle, to roll on and off the platform, and a raised condition wherein the platform supports the appliance inside the compartment.

8. The apparatus of claim 7, wherein the compartment is disposed immediately below a cargo area of the vehicle.

9. The apparatus of claim 8, wherein a floor separates the cargo area from the compartment, and a pass-through opening is formed in the floor to permit objects to be exchanged between the cargo area of the motor vehicle and a cargo area of the appliance.

10. The apparatus of claim 7, wherein the platform, when in the lowered condition, is positioned such that at least a portion of the platform is adjacent to the surface to allow the appliance to roll on and off the platform.

11. The apparatus of claim 10, wherein a first end of the platform is pivotably mounted to the vehicle and a second end of the platform can be lowered toward the surface such that the platform is inclined relative to the surface.

12. The apparatus of claim 7, wherein the appliance is an unmanned ground vehicle.

13. Apparatus comprising:
a rolling appliance;
a motor vehicle having an internal compartment; and
a lift secured to a body of the vehicle adjacent to a lower opening of the compartment and movable between a lowered condition wherein the lift is positioned for engagement with and disengagement from the rolling appliance located on a surface below the lower opening, and a raised condition wherein the lift supports the rolling appliance inside the compartment.

14. The apparatus of claim 13, wherein the compartment is disposed immediately below a cargo area of the vehicle.

15. The apparatus of claim 14, wherein a floor separates the cargo area from the compartment, and a pass-through opening is formed in the floor to permit objects to be exchanged between the cargo area of the motor vehicle and a cargo area of the appliance.

16. The apparatus of claim 13, wherein the lift comprises a platform that, when in the lowered condition, is positioned such that at least a portion of the platform is adjacent to a ground surface to allow the appliance to roll on and off the platform.

17. The apparatus of claim 16, wherein a first end of the platform is pivotably mounted to the vehicle and a second end of the platform can be lowered toward the surface such that the platform is inclined relative to the surface.

18. The apparatus of claim 13, wherein the appliance is an unmanned ground vehicle.

19. The apparatus of claim 13, wherein the lift comprises at least one clamp operable to alternatively grip and release the appliance when the clamp is in the lowered condition.
